(19) United States
(12) Patent Application Publication
(10) Pub. No.: US 2004/0041837 A1
(43) Pub. Date: Mar. 4, 2004

(54) Gui part focus movement destination setter and focus moving device

(76) Inventors: Naoto Yamaguchi, Chiba (JP); Akira Ishikawa, Kanagawa (JP)

Correspondence Address: GREENBLUM & BERNSTEIN, P.L.C., 1950 ROLAND CLARKE PLACE, RESTON, VA, 20191, US

(21) Appl. No.: 10/416,493

(22) PCT Filed: Sep. 13, 2002
(86) PCT No.: PCT/JP02/09405

(30) Foreign Application Priority Data
Sep. 13, 2001 (JP) 2001-278370

(51) Int. Cl. G09G 5/00

(52) U.S. Cl. 345/764

(57) ABSTRACT

A GUI part focus destination setting apparatus comprises searching means for searching a destination GUI part of a focus, which moves based on an operational direction of operating means in a state that a target GUI part is used as a starting point, in a search range in each direction around the target GUI part; and setting means for setting the searched GUI part as a destination of the focus corresponding to the operational direction where the target GUI part is used as a starting point. The searching means varies the search range. This makes it possible to fix the range in each direction and to set a focus moving direction, which is suitable for the arrangement of GUI parts, and a focus moving direction where a user can perform operations easily.

### TECHNICAL FIELD

The present invention relates to a GUI part focus destination setting apparatus to decide a focus destination between GUI parts that form a graphical user interface (GUI), and a focus moving apparatus that executes focus movement and particularly to improvement in operability of a focus moving operation.

### BACKGROUND ART

In many information apparatuses such as personal computers (hereinafter referred to as PCs), TVs, cellular phones, and the like, kinds of equipment using a graphical user interface (GUI) have been increased in recent years.

A GUI screen is composed of GUI parts such as a link, a button, a list, a check box, etc., displayed on a screen. Each GUI part is a fixed-shape image, which is provided with a specific property and which is formed of a character or a picture, and is an object to be subjected to selection, operation, or information input from a user.

In connection with the system in which the user selects an arbitrary GUI part from among a plurality of GUI parts, there are used one system in which the corresponding GUI part is directly selected by a cursor using a pointing device such as a mouse and the like as in the personal computer and the other system in which the GUI part is selected using the directional key of a remote control that controls TV and the like, a keyboard, etc. In the latter system, when the user operates the directional key of the remote control and the like, a GUI part currently selected from among the plurality of GUI parts is displayed by a dotted frame or displayed in the form that the color or shape is changed. In this way, a mark, which makes it possible to identify the GUI part currently selected from among the plurality of GUI parts, is called “focus.” The user operates the directional key of the remote control and the like, thereby the focus moves on the GUI part. In the GUI part that has obtained the focus, its color and shape change and this makes it possible to visually clearly distinguish from other GUI parts.

In a GUI application that executes the selection of the GUI part using such the focus system, it is necessary to determine to which GUI part the focus should be moved from the GUI part that has currently obtained the focus when the user performs a focus moving operation, for example, depression of the directional key.

For this reason, as illustrated in FIG. 1, in a case where a button 1, a button 2, and a button 3, which are used as GUI parts, are present on a GUI screen, the relationship in upper, lower, right and left positions among the respective GUI parts is preset to be held as in such a case that “the button 2 is positioned in a lower direction to the button 1” and “the button 3 is positioned in a right direction to the button 1.” When the user depresses the lower directional key in a state that the button 1 obtains the focus, the focus is moved to the button 2, and when depressing the right directional key, the focus is moved to the button 3.

Moreover, Unexamined Japanese Patent Publication 2000-200129 (focus controlling apparatus) describes a method that specifies a destination GUI part by calculation when the user depresses the directional key without presetting the relationship in upper, lower, right and left positions among the respective GUI parts. According to this method, if the GUI part at which the current focus is positioned is the button 2 as shown in FIG. 2, a GUI part, which is within the range of 90° around each of the upper, lower, right, left directions the lower direction of the button 2 and which has a minimum direction seen from the button 2, is specified as a focus destination in each direction of the button 2.

Accordingly, when the user depresses the right directional key, a GUI part, which is within the range of 90° around the right direction of the button 2 and which has a minimum direction from the button 2, is calculated, so that a button 4 is specified as a focus destination. Moreover, when the user depresses the lower directional key, a GUI part, which is within the range of 90° around the lower direction of the button 2 and which has a minimum direction from the button 2, is calculated, so that a button 5 is specified as a focus destination.

This method eliminates the need for presetting the relationship in upper, lower, right and left positions among the respective GUI parts one by one, making it efficient to create a GUI application.

Moreover, Unexamined Japanese Patent Publication 10-812871 (Internet TV apparatus) describes a method that specifies a destination GUI part by calculation to be explained below. Namely, there is described a method in which regarding the right and left directions, seeing from each of the right and left directions from a typical point (central point) of a target GUI part, one that has the shortest distance from the target GUI part is selected as a focus destination from GUI parts just beside one another (their coordinates of the typical points in the vertical direction are included in a coordinate range of the target GUI part in the vertical direction) and, regarding the upper and lower directions, one that has the closest horizontal coordinate is selected as a focus destination from GUI parts whose vertical coordinates are close to one another, excepting the aforementioned GUI parts just beside another.

In this way, the focus destination in each of the upper, lower, right, and left of the GUI part can be specified by calculation.

However, the focus destination setting methods described in the above publications fix the respective upper, lower, right, and left ranges (the respective upper, lower, right, and left ranges are equally divided into four in the method described in Unexamined Japanese Patent Publication 2000-200129, and all excepting GUI parts just beside another are moved by upper and lower operations and the upper and lower ranges are resultantly fixed to be widely taken as a matter of fact in the method described in Unexamined Japanese Patent Publication 10-812871). For this reason, poor operability occurs depending on the arrangement of GUI parts on the GUI screen.

For example, in the case where the respective upper, lower, right, and left ranges are equally divided into four and fixed, the typical points (central points) of the button 1 and button 3 are included in the upper range of the button 2 as shown in FIG. 3. Moreover, when the distance between the button 2 and the button 1 is shorter than the distance between the button 2 and button 3, the user cannot directly move the focus from the button 2 to the button 3. In this case, the user must depress the upper directional key to move the focus from the button 2 to the button 1, and then depress the right directional key to move the focus from the button 1 to the button 3.

Furthermore, in the case where the upper and lower ranges are fixed to be widely taken, the focus destination in the upper direction from the respective GUI parts 11, 12, 13, 14, and 15 is a GUI part 16 when the GUI parts are arranged as shown in FIG. 4. However, the focus destination of the GUI part 16 in the lower direction is always GUI part 13. For this reason, for example, even if the focus moving operation in the upper direction from the GUI part 11 is performed and the focus moving operation to a reverse direction (lower direction) in terms of the operation is sequentially performed, the focus does not return to the GUI part 11.

In this way, the focus does not return to the original GUI part by the focus moving operation to the reverse direction, and this is greatly unnatural and inconvenience for the users. For example, when the user erroneously moves the focus in an unwanted direction, the focus does not return to the original GUI part and moves to a different GUI part even if the operation to the reverse direction is performed. As a result, it takes time and labor to perform the operation for returning the focus to the original GUI part.

### DISCLOSURE OF INVENTION

An object of the present invention is to provide a GUI part focus destination setting apparatus that is capable of improving operability in focus movement of GUI parts and a focus moving apparatus.

The above object can be attained by varying a range to be searched in accordance with setting of a focus destination of a GUI part to set a destination that coincides with the contents of display.

### BRIEF DESCRIPTION OF DRAWINGS

FIG. 1 is a view showing an example of arrangement of GUI parts;

FIG. 2 is a view explaining a conventional focus destination calculation method;

FIG. 3 is a view explaining the problem of the conventional focus destination setting method;

FIG. 4 is a view explaining the other problem of the conventional focus destination setting method;

FIG. 5 is a block diagram showing the configuration of a focus destination setting apparatus according to Embodiment 1 of the present invention;

FIG. 6 is a block diagram showing the configuration of a cellular phone equipped with the focus destination setting apparatus according to Embodiment 1;

FIG. 7 is a plane view showing the outline of the configuration of the cellular phone equipped with the focus destination setting apparatus according to Embodiment 1;

FIG. 8 is a view showing an example of arrangement of GUI parts according to Embodiment 1;

FIG. 9 is a view showing GUI position information according to Embodiment 1;

FIG. 10 is a view showing set range information according to Embodiment 1;

FIG. 11 is a view showing a GUI screen where range information is input according to Embodiment 1;

FIG. 12 is a flowchart showing a focus destination calculation processing steps according to Embodiment 1;

FIG. 13 is a view showing a focus destination list according to Embodiment 1;

FIG. 14 is a view explaining improvement in the operability of a focus moving operation according to Embodiment 1;

FIG. 15 is a view explaining a directional range where upper, lower, right, and left focus moving operations are needed according to Embodiment 1;

FIG. 16 is a view explaining a directional range where only right and left focus moving operations are possible according to Embodiment 1;

FIG. 17 is a flowchart showing operation steps when focus destination calculation processing is performed at an application starting time according to Embodiment 1;

FIG. 18 is a view explaining the problem solved by a focus destination setting apparatus according to Embodiment 2;

FIG. 19 is a view showing a focus destination list when a GUI part that cannot obtain its focus is present according to Embodiment 2;

FIG. 20 is a view explaining resetting of range information performed by the focus destination setting apparatus according to Embodiment 1;

FIG. 21 is a flowchart showing the operations of the focus destination setting apparatus according to Embodiment 2;

FIG. 22 is a view showing a focus destination list set by the focus destination setting apparatus according to Embodiment 2;

FIG. 23 is a view showing a general focus moving direction to the two-stage arrangement of GUI parts according to Embodiment 3;

FIG. 24 is a view showing a focus destination list that designates a general focus moving direction to the two-stage arrangement of GUI parts according to Embodiment 3;

FIG. 25 is a view showing a focus moving direction set by the focus destination setting apparatus according to Embodiment 3;

FIG. 26 is a view explaining presetting to the focus destination list according to Embodiment 3;

FIG. 27 is a view a focus destination list set by the focus destination setting apparatus according to Embodiment 3;

FIG. 28 is a view showing a GUI screen for presetting the focus destination according to Embodiment 3;

FIG. 29 is a flowchart showing the operations of the focus destination setting apparatus according to Embodiment 3;

FIG. 30 is a flowchart showing the operations of the focus destination setting apparatus according to Embodiment 4;

FIG. 31 is a view showing a focus destination list set by the focus destination setting apparatus according to Embodiment 4;

FIG. 32 is a block diagram showing the configuration of a focus moving apparatus according to Embodiment 5;

FIG. 33 is a view showing a history stored by history storing means according to Embodiment 5;

FIG. 34 is a view showing the focus moving direction corresponding to the arrangement of GUI parts according to Embodiment 5;

FIG. 35 is a view showing a focus destination list according to Embodiment 5; and

FIG. 36 is a flowchart showing the operations of the focus moving apparatus according to Embodiment 5.

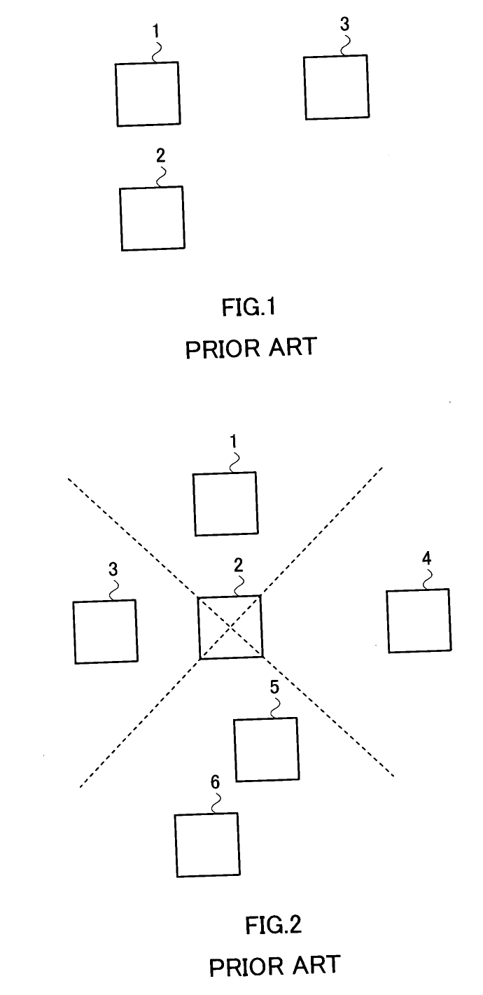

### BEST MODE FOR CARRYING OUT THE INVENTION

The following will explain the embodiments of the present invention with reference to the drawings.

(Embodiment 1)

The GUI part focus destination setting apparatus of Embodiment 1 of the present invention can arbitrarily set the respective upper, lower, right and left search ranges of each GUI part at the time of calculating the GUI part focus destination.

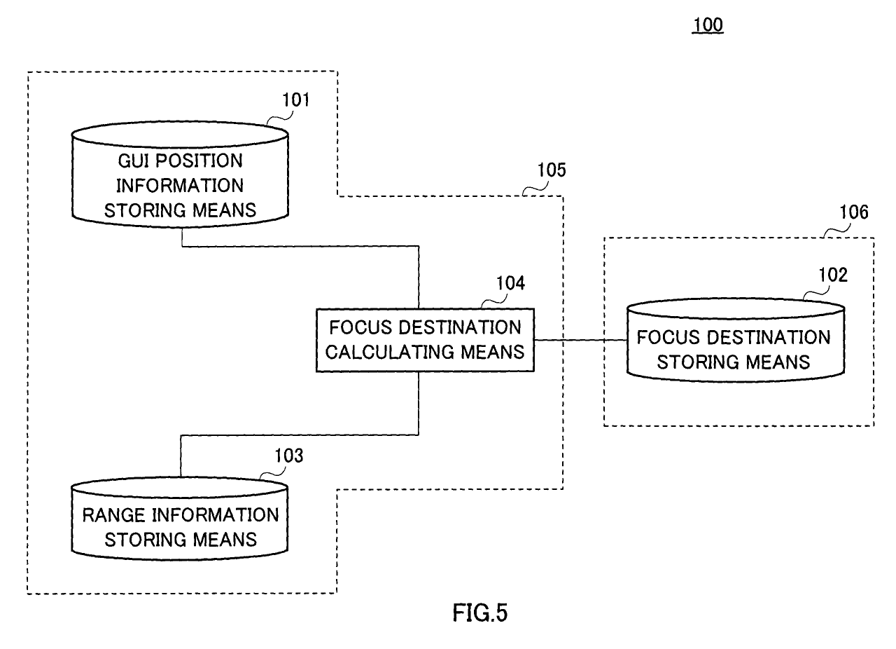

As shown in FIG. 5, a focus destination setting apparatus 100 is composed of GUI position information storing means 101 that stores the positions of the respective GUI parts which form a GUI, range information storing means 103 that stores the respective upper, lower, right and left ranges which have been set, focus destination calculating means 104 that calculates a focus destination from each GUI part based on position information of each GUI part stored in the GUI position storing means 101 and range information stored in the range information storing means 103, and focus destination storing means 102 that stores a focus destination from each GUI part calculated by the focus destination calculating means 104.

Moreover, in FIG. 5, the GUI position information storing means 101, range information storing means 103, and focus destination calculating means 104 configures searching means for setting a destination GUI part. Further, focus destination storing means 102 stores a GUI part searched by the searching means therein, thereby configuring means for setting the GUI part as a destination.

Additionally, the function of focus destination calculating means 104, and the data writing and reading functions of GUI position information storing means 101, range information storing means 103 and focus destination storing means 102 are implemented when a CPU executes processing according to various kinds of control programs stored in memory. Moreover, these processing steps are executed when a user and an operator operates input means such as a keyboard and the like.

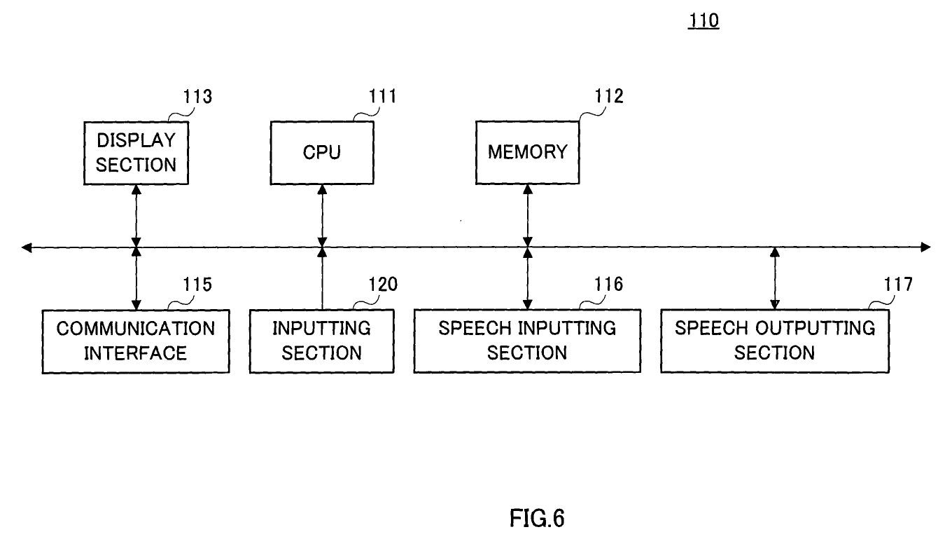

FIG. 6 is a block diagram showing a cellular phone 110 equipped with the focus destination setting apparatus 100 shown in FIG. 5. As shown in FIG. 5, the cellular phone 110 includes such components via a data bus that are a CPU (Central Processing Unit) 111, a memory 112, a display section 113, an input section 120 including directional keys and numerical keys, a communication interface 115 for receiving and transmitting various kinds of signals (sound signal at the time of communication, contents data and the like at the time of obtaining contents) via a cellular phone network, a speech input section (microphone) 116 that inputs sound at the time of communication and a speech outputting section (speaker) 117 that outputs sound from a communication partner at the time of communication.

When executing the program stored in the memory 112, the CPU 111 stores data of a processing result to the memory 112. The user inputs various commands using the directional keys and numerical keys to cause the CPU 111 to execute various kinds of processing.

Moreover, the display section 113 visually displays the processing contents executed by the CPU 111 and the processing result. The communication interface 115 receives/transmits the voice signal from/to the communication partner via the cellular phone network or receives/transmits data from/to various kinds of servers via a network such as the Internet and the like.

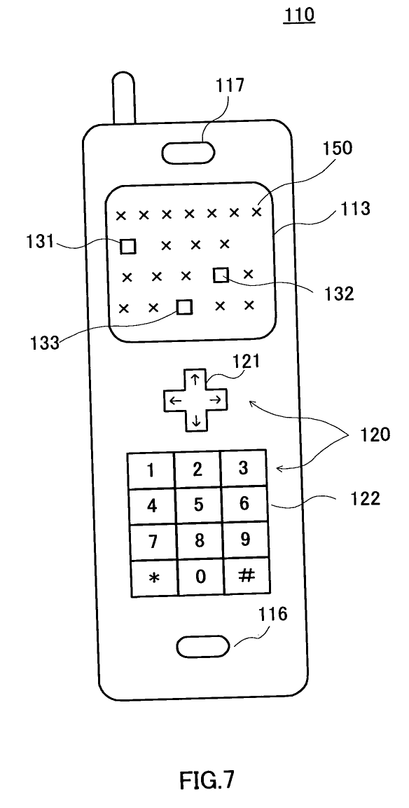

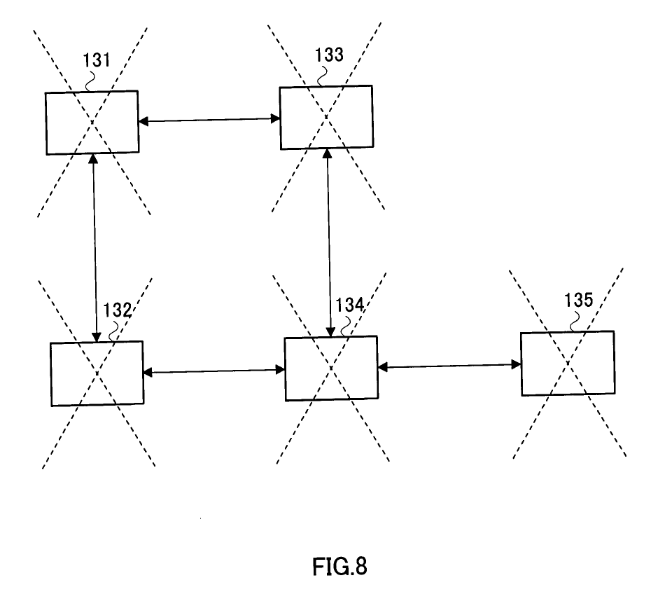

FIG. 7 is a plane view showing the outline of the cellular phone 110. As shown in FIG. 7, the housing body of the cellular phone 110 is provided with the display section 113, input section 120 including the directional keys 121 and numerical keys 122, voice input section 116, and voice output section 117.

When the contents are downloaded from the network such the Internet and the like by the cellular phone 110, the contents are displayed on the display section 113. On the display screen, GUI parts 131, 132, 133, . . . are displayed in addition to, for example, text data 150. The user operates the directional keys 121 that can designate the upper, lower, right and left directions, thereby making it possible to select any one of GUI parts 131, 132, 133, . . . .

The above-configured terminal apparatus 110 is equipped with the focus destination setting apparatus 100 shown in FIG. 5. More specifically, the focus destination calculating means 104 of focus destination setting apparatus 100 is implemented when the CPU 111 executes a focus destination calculation program stored in the memory 112, and the GUI position information storing means 101, focus destination storing means 101, and range information storing means 102 are implemented by the memory 112 and CPU 111, respectively.

The terminal apparatus 110 is configured to download the various contents from the network (server) via the communication interface 115, and store the downloaded contents to the memory 112. The stored contents are read and executed by the CPU 111.

In this case, the contents are displayed on the display section 113, and the user operates the input section 114, thereby processing is performed according to the operation result. For example, a case is assumed that the text data 150 is displayed on the display screen of the display section 113 to provide various information to the user as shown in FIG. 7. In this case, GUI parts 131, 132, 133 . . . are displayed on the display screen together with the text data 150, and the user operates the directional key 121 in any one of upper, down, right and left directions, thereby making it possible to move the focus to any one of the GUI parts 131, 132, 133, . . . , and to select the GUI part of the corresponding destination.

The cellular phone 110 is configured such that each GUI part is used as a starting point at the time of operating the directional key 121 and GUI parts at the destination where their focuses should be moved according to the operational direction can be preset as destination information for each GUI part. This makes it possible to move the focus according to the contents with a more natural operational feeling.

The following will explain focus destination setting processing by the focus destination setting apparatus 110 shown in FIG. 5. In the case of this embodiment, the focus destination setting apparatus 110 of cellular phone 110 once stores range information, which has been added as a tag to the contents downloaded from the server, to the range information storing means 103 (memory 112), and sets each destination of the GUI parts 131, 132, 133, . . . based on the stored range information.

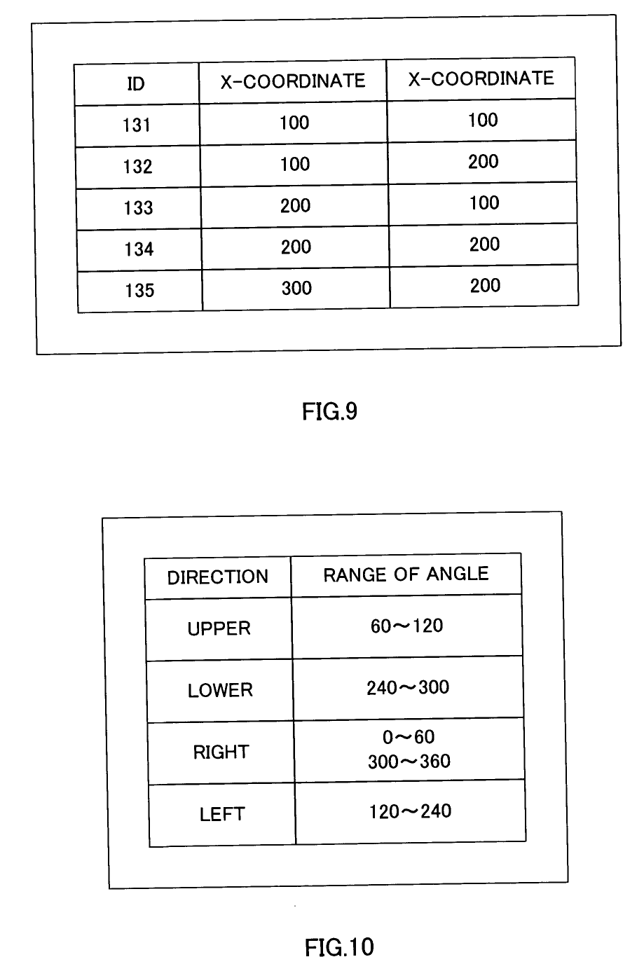

More specifically, the GUI position information storing means 101 stores the coordinates of the points, which represent the positions of the respective GUI parts that form the GUI by downloading the contents. When the respective GUI parts (GUI parts 131 to 135) are arranged on the GUI screen where the GUI parts are displayed as shown in FIG. 8, in the GUI position information storing means 101, there is stored a list in which ID of each GUI part and an X-coordinate and a Y-coordinate (here, Y-coordinate is positioned downward), which are a typical point (for example, central point) of the GUI part, are associated with one another as shown in FIG. 9.

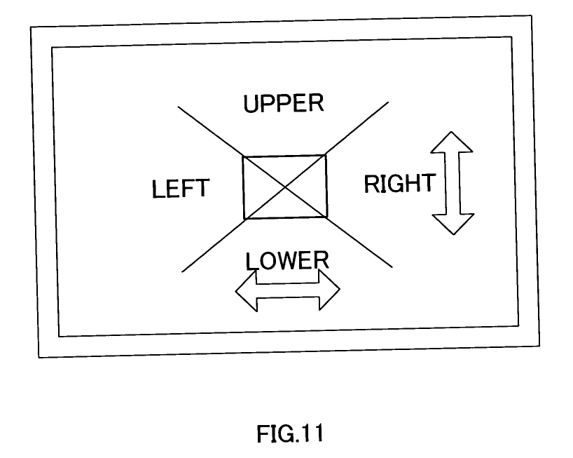

The range information storing means 103 stores, as range information, the range of the angle in each direction of upper, lower, right and left as range information as shown in FIG. 10. In FIG. 8, a boundary line, which defines the range in each direction of upper, lower, right and left of each GUI part, is illustrated by a dotted line. In the case of this embodiment, the range information is set when the operator on the server side downloads one, which has been set according to the contents, to the cellular phone 110 to store to the range information storing means 103. However, in place of this, the user may directly input and designate a numerical value, or as shown in FIG. 11, the designation may be performed by displaying each range graphically to move the range by the directional button of the remote control and the like.

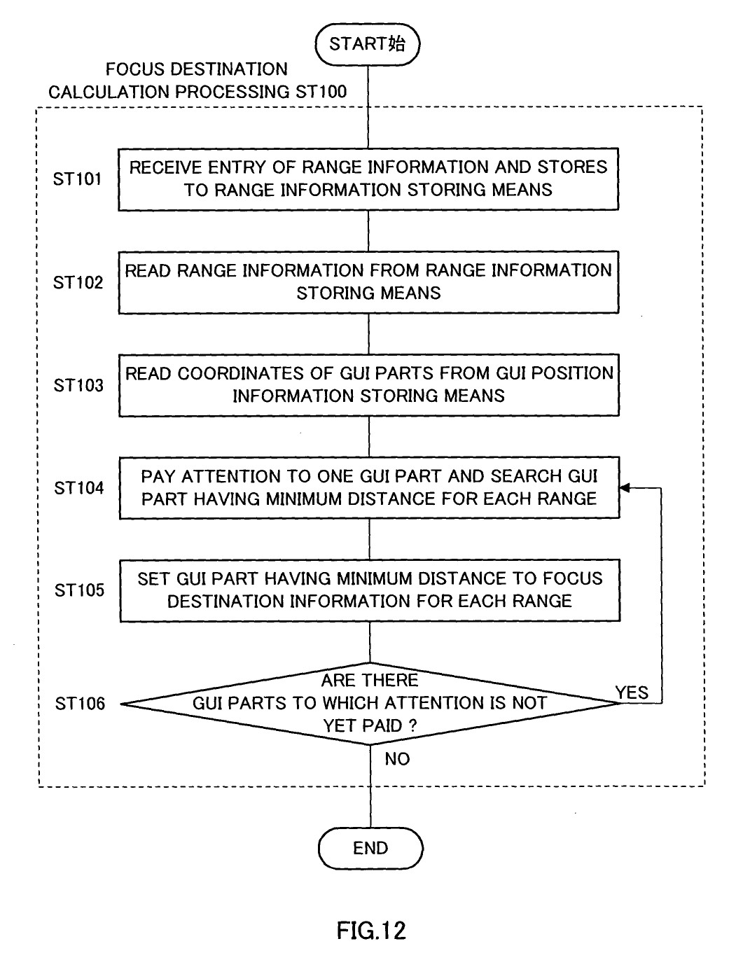

The focus destination calculating means 104 reads position information of each GUI part from the GUI position information storing means 104 or reads range information from the range information storing means 103, and calculates the focus destination in each direction of the upper, lower, right, and left of each GUI part. A flowchart of FIG. 12 shows calculation processing steps (step ST100) of the focus destination calculating means 104.

Step ST101: The range information storing means 103 receives the entry of range information and stores it.

Step ST102: The focus destination calculating means 104 reads range information from the range information storing means 103.

Step ST103: The focus destination calculating means 104 reads the coordinates of GUI parts from the position information storing means 101.

Step ST104: The focus destination calculating means 104 pays attention to one GUI part, calculates the distance between the target GUI part and each of other GUI parts, and finds out a GUI part having the minimum distance for each range of the upper, lower, right and left. Regarding to which range other GUI parts are included, this can be determined by comparing the angle of a straight line, which connects the coordinates of the relevant GUI part and those of the target GUI part, with range information. Additionally, there can be a case in which there is a direction where no GUI part is present when the target GUI part is placed at the corner of the GUI screen.

Step ST105: The focus destination calculating means 104 causes the focus destination storing means 102 to store the GUI part having the minimum distance in each direction, which has been found out in step ST104, as the focus destination of the direction.

When there is no such GUI part, “absence” is left as it is.

Step ST106: If there are left GUI parts to which attention is not yet paid, attention is paid to any of these and the steps in step ST104 and the following are repeated. If there is no GUI part to which attention is not paid, processing is ended.

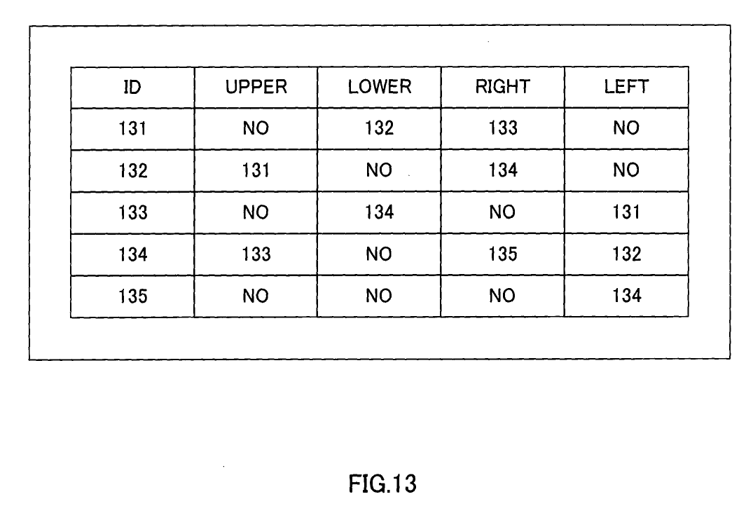

The focus destination storing means 102 holds a focus destination list shown in FIG. 13, describes a focus destination GUI part ID in each direction of the upper, lower, right, and left of each GUI part in the list, and stores the focus destination. Initially, “absence” is descried in all columns of this list showing the upper, lower, right, and left. Every time when the focus destination calculating means 104 determines a GUI part as a focus destination in step ST105, ID of the GUI part is described in the corresponding column. FIG. 13 shows the focus destination list in which the focus destinations of all GUI parts are calculated and recorded from the arrangement of the GUI parts of FIG. 8.

At the actual using time after setting, the focus destination list stored in the focus destination storing means 102 is used as reference by a GUI application when the user operates the directional key 121 and performs the focus moving operation on the GUI screen. From the GUI part where the current focus is positioned and the direction designated by the user, a focus destination GUI part is determined based on this list, and focus movement is performed according to the determination result.

Thus, in the focus destination setting apparatus 100, the search range in each direction of each GUI part at the time of specifying a focus destination by calculation can be arbitrarily set by storing the downloaded range information to the range information storing means 103.

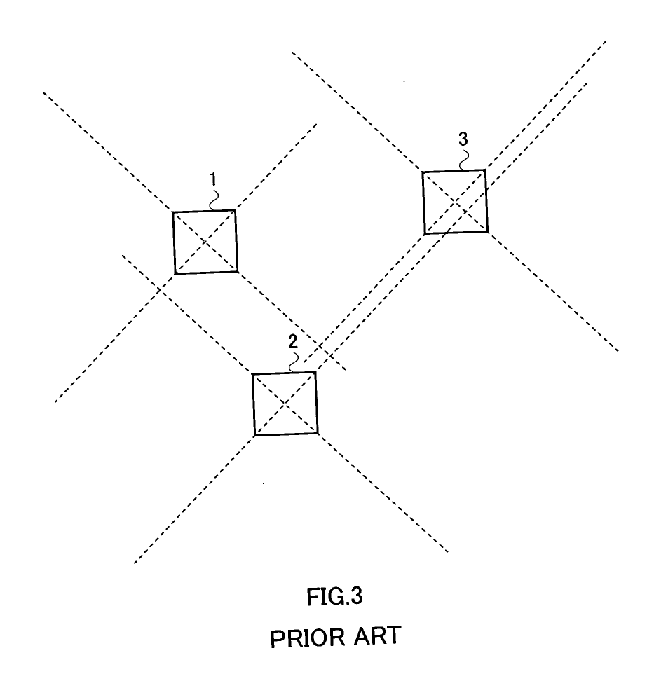

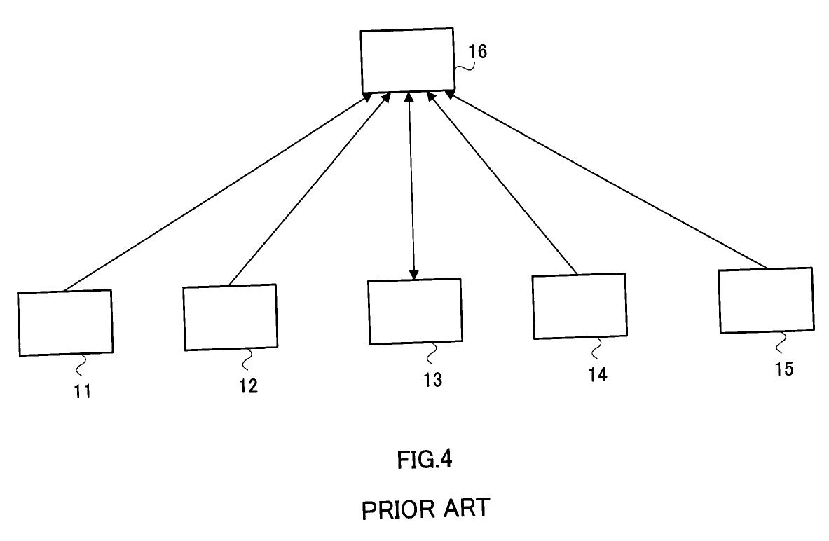

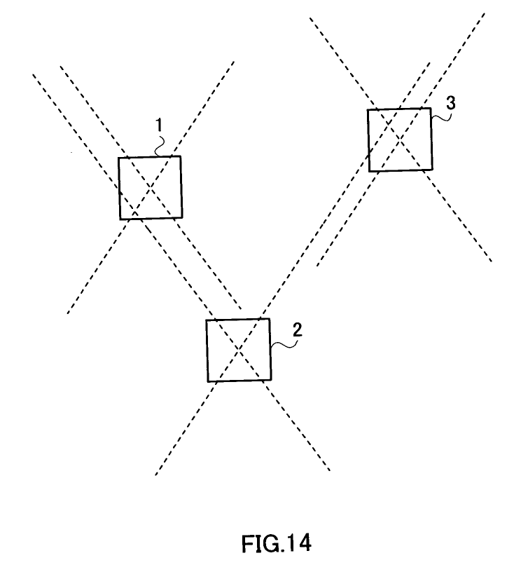

As a result, even if the GUI parts are arranged on the GUI screen as shown in FIG. 3, the range in the right direction is set such that the central point of the button 3 as a GUI part is included in the range in the right direction of the button 2 as shown in FIG. 14, thereby making it possible to directly move the focus to the button 3 from the button 2 by the focus moving operation to the right direction. Such setting is conducted by the operator, who creates range information, and is downloaded to the terminal apparatus such as the cellular phone 110, and the like.

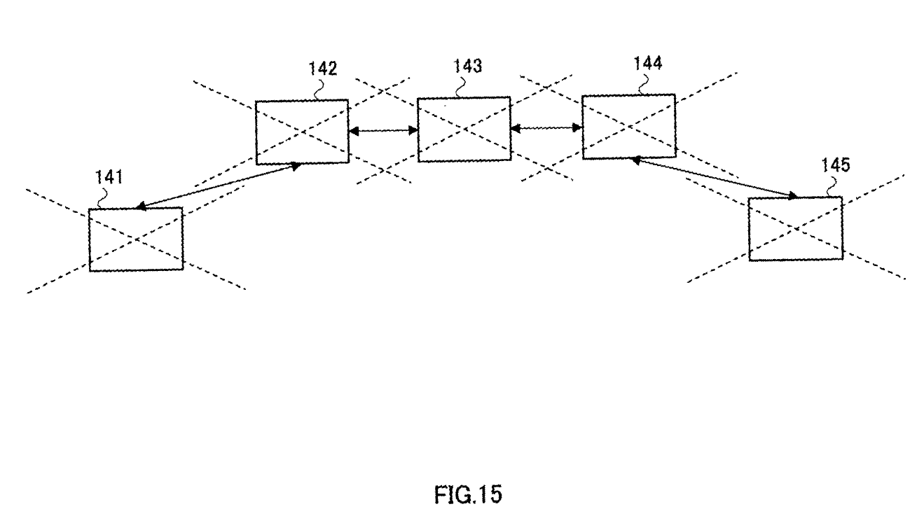

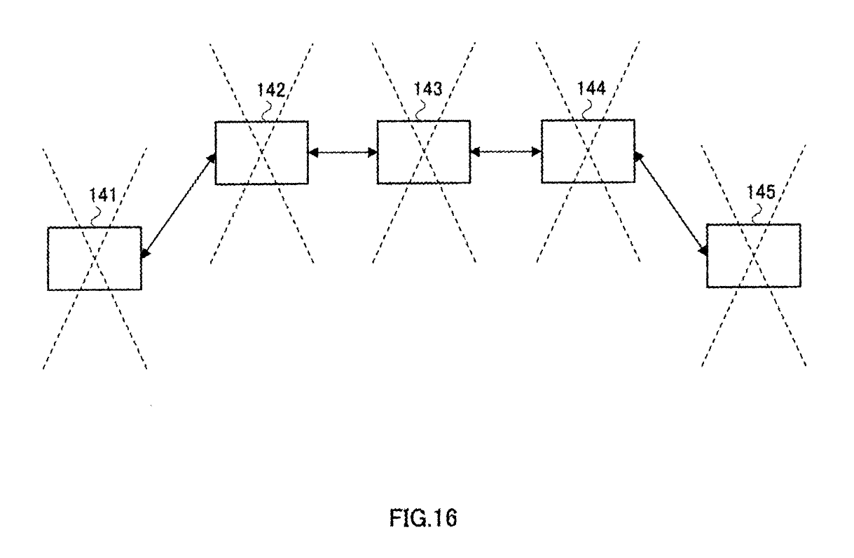

Moreover, in a case where a plurality of GUI parts 141 to 145 is arranged to be slightly shifted up and down from a horizontal straight line as shown in FIG. 15, all operations in the upper, lower, right and left directions are included as the focus moving operations when the ranges in the upper, lower, right and left directions are fixed to be wider in the upper and lower directions as shown by the dotted boundary lines. However, the right and left ranges are widely set as shown in FIG. 16, thereby making it possible to select all GUI parts 141 to 145 by only right and left focus moving operations.

Thus, in the focus destination setting apparatus 100, the range in each direction from each GUI part is suitably defined, making it possible to set the focus moving operation appropriate for the arrangement of GUI parts and to improve operability.

The way to set the range information is not limited to downloading it with the contents. For example, a creator (provider) of the GUI application on the server side sets range information and the cellular phone 110 may obtain the setting result. Or, a GUI application user (user), who desires to customize the focus moving operation, operates the cellular phone 110, thereby making it possible to set range information.

In the case that the user sets it, at the application starting time, processing including step ST101 to step ST106 in FIG. 12 (focus destination calculation processing step ST100) is performed, and GUI application is started as shown by the flowchart in FIG. 17. The user can set the focus moving operation by inputting range information of each direction such that user can perform operation easily.

Additionally, though range information of each direction is here expressed by the angle, this may be expressed by the inclination of the boundary line and the like.

Moreover, though the direction from the GUI part is divided into four, the number of divisions may be other numeral numbers.

Still moreover, the above explains the case in which a specific numeral value (angle, and the like) are used as range information downloaded from the server. However, the present invention is not limited to this. Information representing the feature of the contents may be downloaded to the cellular phone 110 in accordance with the contents. In this case, the GUI application of the focus destination setting apparatus 100 provided in the cellular phone 110 selects a specific numerical value (angle, and the like) based on information representing the feature of the contents, and causes the range information storing means 103 to store the selected numerical value as range information.

For example, in a case where contents as an object to set a focus destination of GUI part indicate display in which characters are arranged on the display section 113, search a range in the character arranging direction is set to be narrow, thereby making it possible to easily set the GUI part in the character arranging direction as a destination. In this way, in the focus destination setting apparatus 100, specific range information, which correspond to information featuring the contents, is preset in the memory, and the range is set in accordance with the contents, making it possible for the cellular phone side to set the range even if there is no specific range information corresponding to the contents.

(Embodiment 2)

In a case where the range in each direction of each GUI part is arbitrarily set, there is a possibility that a GUI part that cannot obtain its focus will occur depending on the arrangement of GUI parts. Embodiment 2 will explain processing of the focus destination setting apparatus that solves such a disadvantage. The apparatus configuration is the same as Embodiment 1 (FIG. 1).

When the range in each direction of each GUI part is arbitrarily set, a GUI part in which its focus cannot be moved from any GUI part occurs depending on the arrangement of GUI parts in some cases.

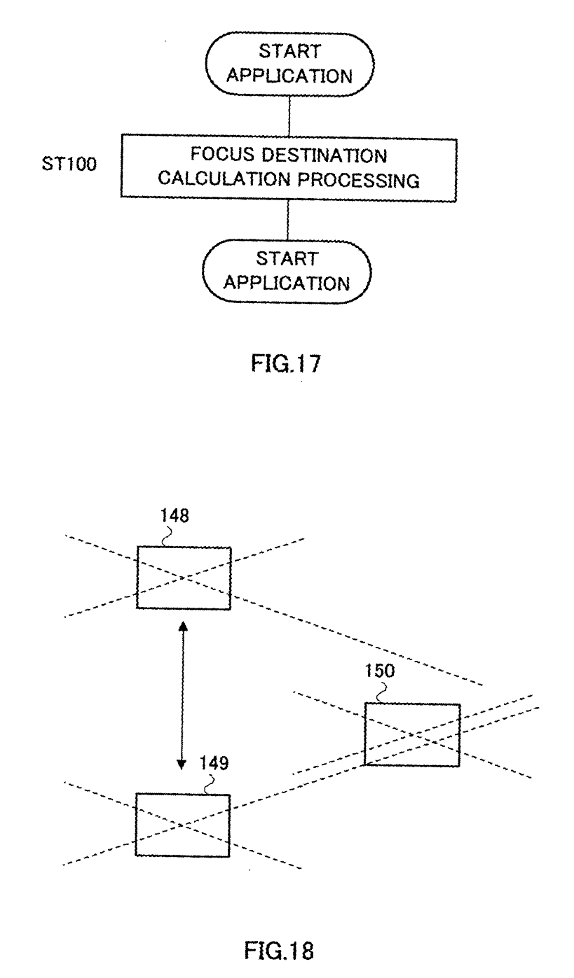

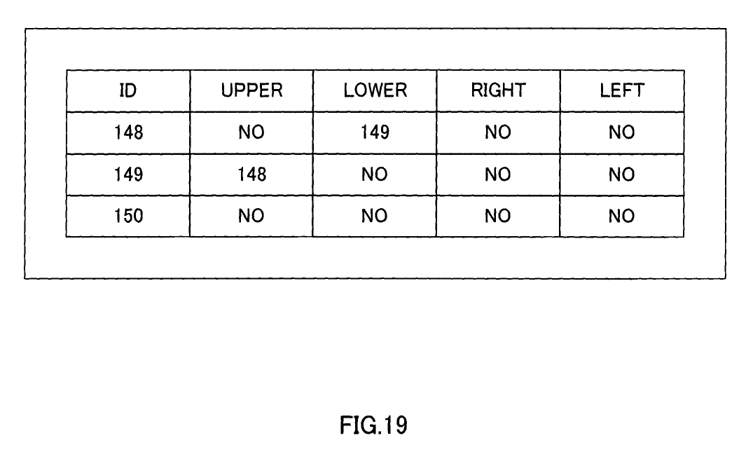

For example, there is a case in which GUI parts 148, 149, and 150 are arranged as shown in FIG. 18 and the ranges in upper and lower directions from each GUI part are provided to be extremely wider than those in right and left directions. In this case, the GUI part 149 is set as a focus destination in the lower direction of the GUI part 148, and the GUI part 148 is set as a focus destination in the upper direction of the GUI part 149. However, the GUI part 150 is included in the same lower direction as the GUI part 149 seen from the GUI part 148, but is placed at a distance from the GUI part 149. Moreover, the GUI part 150 is included in the same upper direction as the GUI part 148 seen from the GUI part 149, but is placed at a distance from the GUI part 148. As a result, the GUI part 150 cannot be designated as a focus destination from both the GUI parts 148 and 149. FIG. 19 shows a focus destination list which is held in the focus destination storing means 102 in this case.

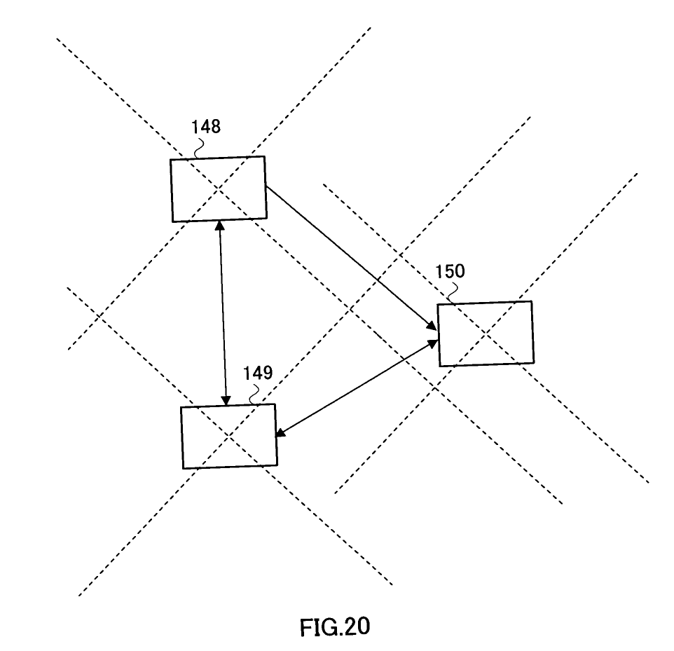

In the case where there is the GUI part that cannot obtain the focus as shown in FIG. 20, the ranges in the wide upper and lower direction are narrowed to widen the ranges in the right and left directions. Then, the ranges in the upper, lower, right, and left directions are changed such that the GUI part 150 is included in a direction different from the GUI part 149 seen from the GUI part 148 or in a direction different from the GUI part 148 seen from the GUI part 149, thereby making it possible for the GUI part 150 to obtain the focus.

Additionally, when the respective upper, lower, right, and left ranges are equally divided into four, there is no generation of GUI part that cannot obtain the focus. The reason is that there is no distance, which is longer than the distance between the target GUI part and the focus destination GUI part, in a square that is formed by a boundary line, which defines the directional range of the target GUI part, and a boundary, which defines the directional range of the focus destination GUI part.

After performing focus destination calculation processing in FIG. 12, the focus destination calculating means 104 of the focus destination setting apparatus checks the presence of the GUI part, which is not set as a focus destination from any GUI part, and urges the operator to reenter range information when there is the corresponding GUI part.

When range information is updated, the focus destination calculating means 104 recalculates the focus destination in each direction of each GUI part, which is not yet decided as a focus destination in the previous focus destination calculation processing (no recalculation is performed to the direction where the GUI part is already decided as a focus destination). The GUI part, which is not yet decided as a focus destination in this recalculation, is newly set as a focus destination. If there is a GUI part that cannot obtain the focus after the update of range information, the focus destination calculating means 104 urges the operator to reenter range information, and repeats the same processing as the above.

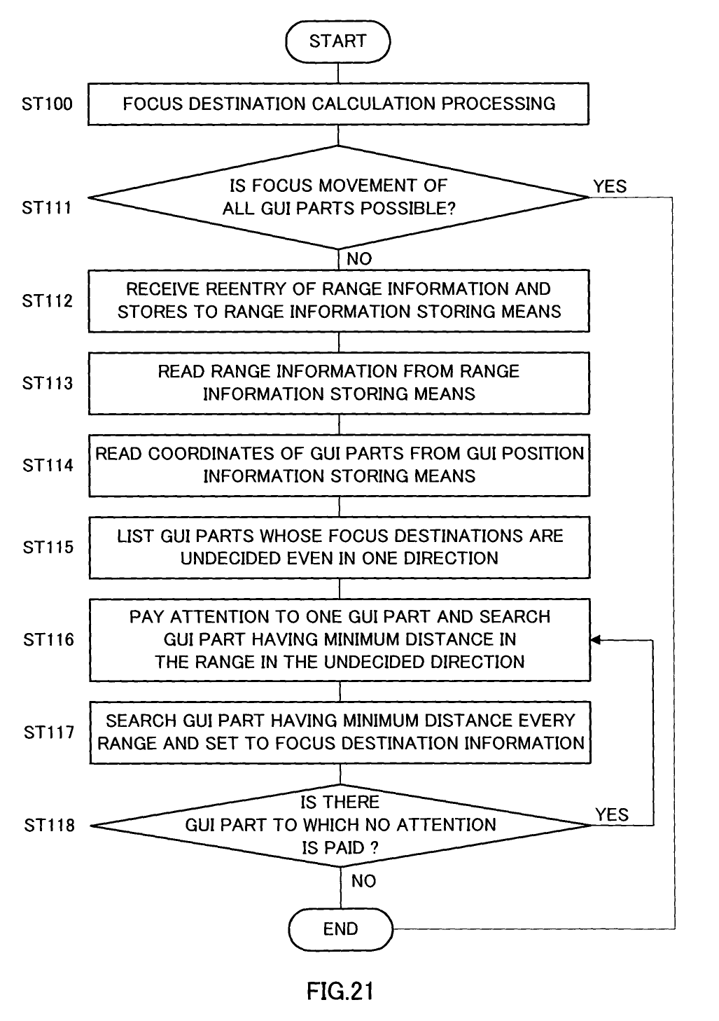

FIG. 21 is a processing flow of the focus destination setting apparatus.

Step ST100: Processing including step ST101 to step ST106 in FIG. 12 is performed.

Step ST111: It is determined whether focus movement of all GUI parts is possible. This determination results in the problem to determine the strong connectedness of a directed graph. For example, this can be determined by the following method.

Attention is paid to a certain GUI part. All GUI parts whose focus movement from the target GUI part is possible are listed. Then, attention is paid to all GUI parts, and this processing is repeated. Thereafter, based on the result of list, it is determined whether focus movement is possible between arbitrary two GUI parts.

When focus movement of all GUI parts is possible, processing is ended. On the other hand, when there is a GUI part 150 whose focus movement is impossible as shown FIG. 18, the following processing is performed:

Step ST112: Range information is stored to the range information storing means 104 upon reception of the reentry of range information. It is assumed that the reentered angle range is a range shown by a dotted line in FIG. 20.

Step ST113: The focus destination calculation means 104 reads range information from the range information storing means 103.

Step ST114: The coordinates of the GUI parts are read from the position information storing means 101.

Step ST115: Next, GUI parts whose focus destinations are undecided even in one direction are listed from the list stored in the focus destination storing means 102. As a result of this processing, GUI parts 148, 149, and 150 including the undecided direction of focus destination (no focus destination) are listed from the focus destination list in FIG. 19.

Step ST116: Attention is paid to one GUI part, and a search for a GUI having the minimum distance from this target GUI part, which is included in the range in the undecided direction of the target GUI part, is performed.

Step ST117: The searched GUI part is described as a focus destination in the corresponding column of the list stored in the focus destination storing means 2.

Step ST118: If there is a GUI part to which no attention is paid in the listed GUI parts, steps in steps ST116 and the following are repeated. Then, when there is no GUI part to which no attention is paid, processing is ended.

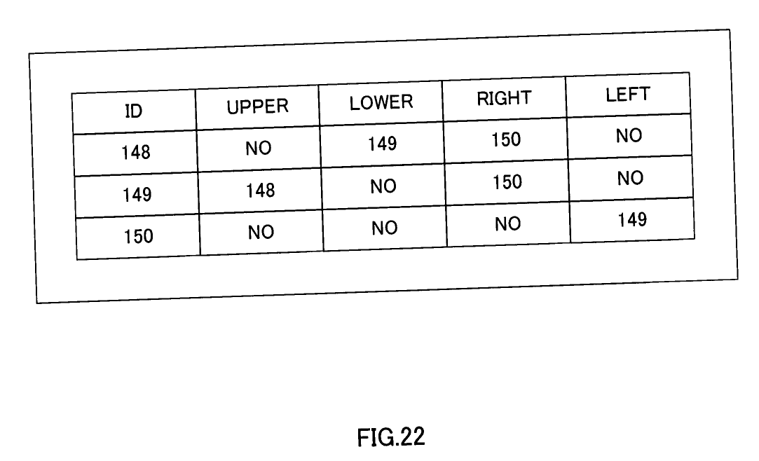

The focus destination list shown in FIG. 22 is stored in the focus destination storing means 102 through such processing. In this list, focus movement to the GUI part with ID150 is possible.

Additionally, when there is a GUI part whose focus movement is impossible, recalculation is performed after the reentry of range information. However, the respective upper, lower, right, and left ranges are equally divided into four, so that processing in step ST113 and the following may be performed.

Thus, the focus destination setting apparatus solves the disadvantage generated when the respective directional ranges of GUI parts are arbitrarily set, and makes it possible for all GUI parts to obtain their focuses.

In this embodiment, the following method is used to determine whether focus movement of all GUI parts is possible. Namely, attention is paid to a certain GUI part. All GUI parts whose focus movement from the target GUI part is possible are listed. Then, attention is paid to all GUI parts, and this processing is repeated. Thereafter, based on the result of list, it is determined whether focus movement is possible between arbitrary two GUI parts. However, the present invention is not limited to this. It is possible to use the following method as described in “Trajan, R. E. “Depth-First Search and Linear Graph Algorithms. “SIAM J. Comput. 1, 146-160, 1972” as an algorithm to determine the strong connectedness. More specifically, the GUI is modeled, GUI parts and focus movement are abstracted to vertexes and an arrow, respectively, the entire GUI is expressed in the concept of graph, and a maximum subgraph that is mutually movable is obtained by an amount of calculation corresponding to the first power of the number of vertexes. By checking this subgraph includes all vertexes, all original GUI parts are connected to one another by focus movement.

(Embodiment 3)

In the focus destination setting apparatus of Embodiment 3, the creator of the GUI application and the GUI application user can individually set the focus destinations of a part of the whole GUI parts. The apparatus configuration is the same as Embodiment 1 (FIG. 1).

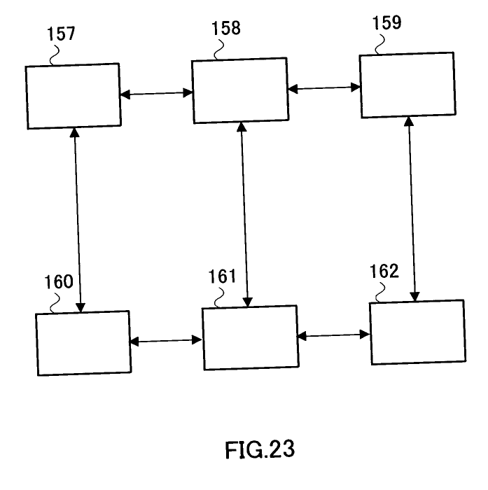

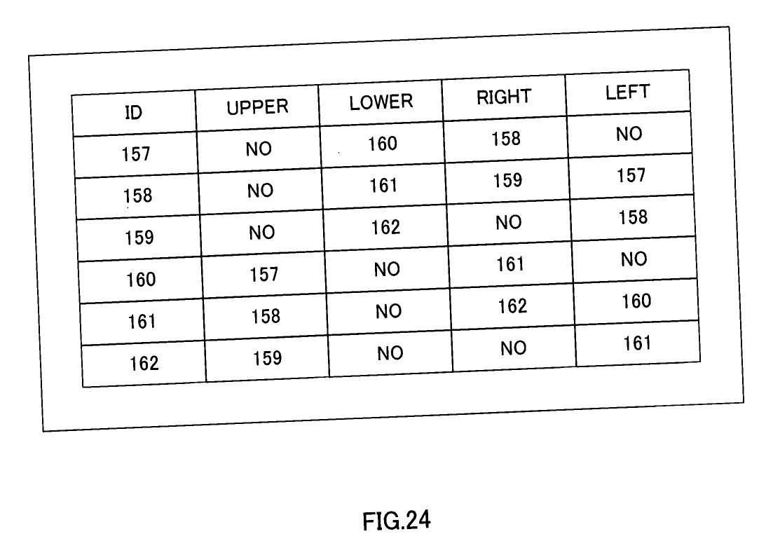

For example, as shown in FIG. 23, when GUI parts are arranged in the form of two stages, a focus destination list shown in FIG. 24 is generated by the focus destination calculation processing explained in Embodiment 1, and the respective focus destination directions are set by arrows in FIG. 23.

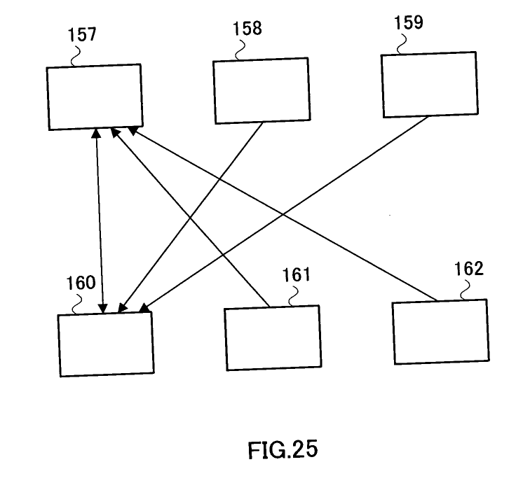

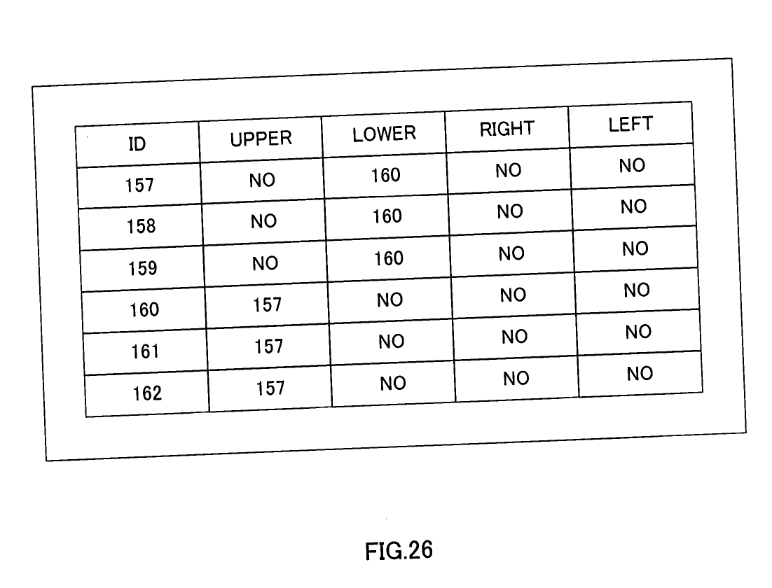

However, in connection with the arrangement of GUI parts, the creator of the GUI application and the GUI application user desire focus movement to GUI parts 157 and 160, which are the heads of the respective stages, at the time of moving the focus to the different stage as shown in FIG. 25, desired focus destinations are respectively set in the focus destination list as shown in FIG. 26.

The focus destination calculating means 104 of this focus destination setting apparatus performs an automatic calculation of each of the focus destinations excepting the directions where GUI parts at their focus destinations are already decided. For this reason, the focus destinations, which are individually set by the creator of the GUI application and the GUI application user, are left in the focus destination list as they are.

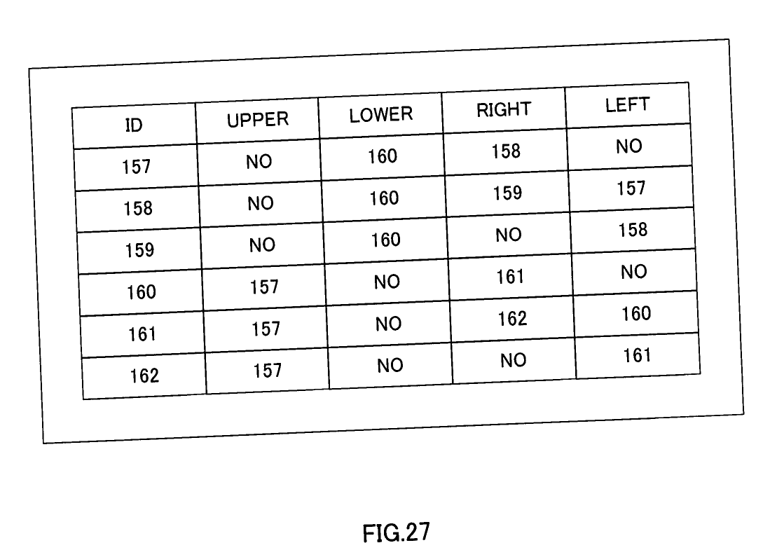

FIG. 27 shows a focus destination list after the focus destination calculation means 104 performs focus destination calculation processing.

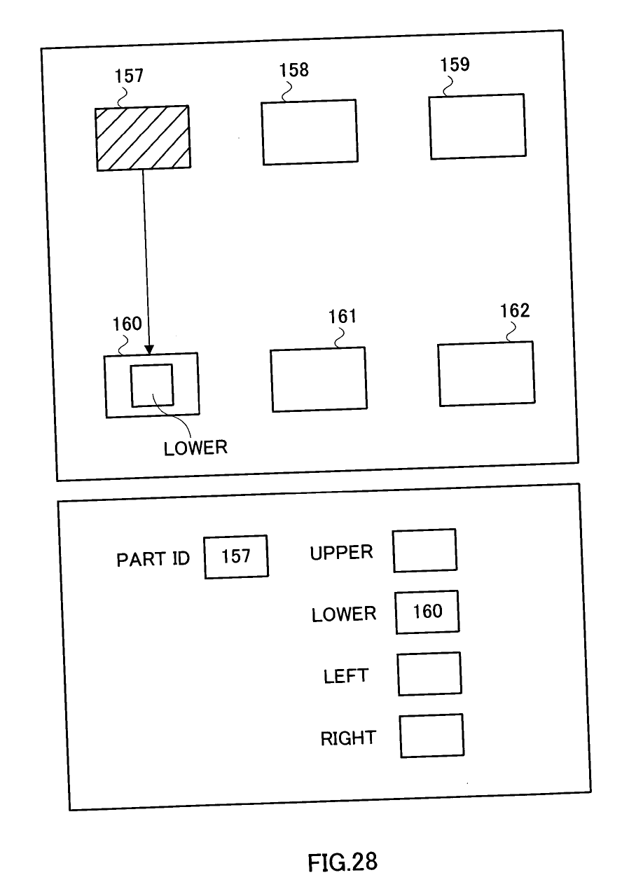

Additionally, in the case where the creator of the GUI application and the GUI application user can individually set the focus destinations of the GUI parts as shown in FIG. 28, the setting screen may be graphically displayed to set the focus destinations through this GUI.

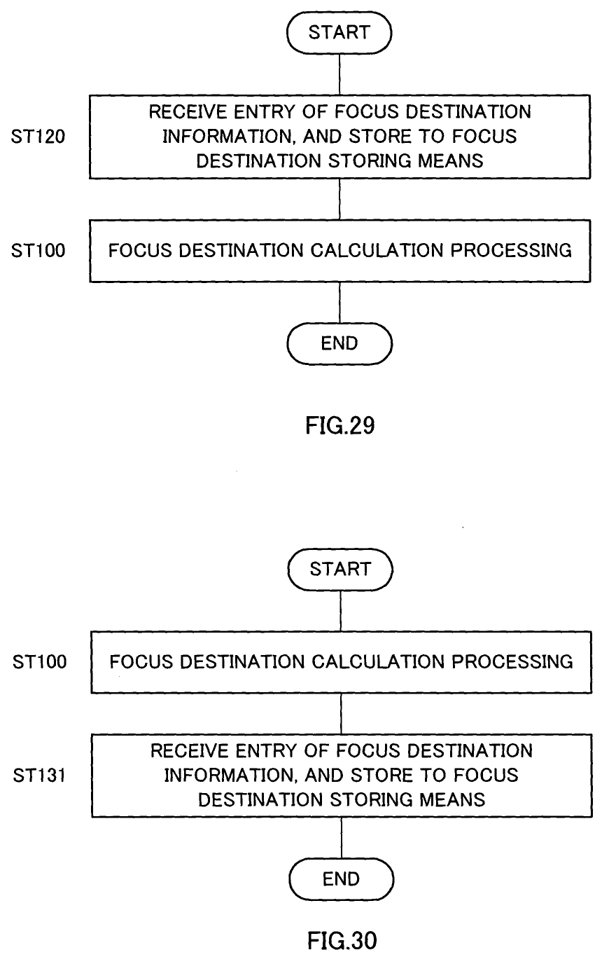

FIG. 29 is a processing flow of this focus destination setting apparatus.

Step ST120: The entry of focus destination information is received and recorded in the focus destination list of the focus movement storing means 102.

Step ST100: Focus destination calculation processing is performed according to the procedures in steps ST101 to ST106 in FIG. 12. In this case, no change is made to the directions where the GUI parts at their focus destinations are already set.

Thus, according to this focus destination setting apparatus, the creator of the GUI application and the GUI application user can individually set the focus destinations of a part of the whole GUI parts.

(Embodiment 4)

In the focus destination setting apparatus of Embodiment 4, the creator of the GUI application and the GUI application user can change automatically calculated focus destination information. The apparatus configuration is the same as Embodiment 1 (FIG. 1).

FIG. 30 is a processing flow of this focus destination setting apparatus.

Step ST100: Focus destination calculation processing is performed according to the procedures in steps ST101 to ST106 in FIG. 12.

Step ST131: The entry of focus destination information is received and recorded in the focus destination list of the focus movement storing means 102.

Thus, in this focus destination setting apparatus, the creator of the GUI application and the GUI application user can individually change the focus destination calculation result.

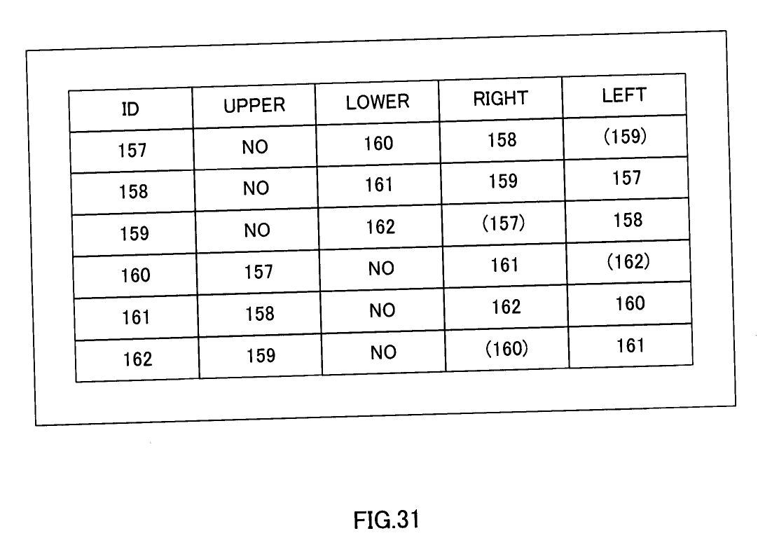

For example, in connection with the arrangement of GUI parts 157 to 162 of FIG. 23, a focus destination list shown in FIG. 24 is generated by focus destination calculation processing, focus destination directions shown by arrows in FIG. 23 are set. However, the creator of the GUI application and the GUI application user add focus destinations, which are expressed by parenthesized numerals, to this focus destination list as shown in FIG. 31. As a result, the focus is moved to the GUI part 159 from the GUI part 157 by the focus moving operation to the left direction. The focus is moved to the GUI part 157 from the GUI part 159 by the focus moving operation to the right direction. The focus is moved to the GUI part 162 from the GUI part 160 by the focus moving operation to the left direction. Moreover, the focus is moved to the GUI part 160 from the GUI part 162 by the focus moving operation to the right direction.

Thus, in this focus destination setting apparatus, it is possible to individually reset the automatically calculated focus destination calculation result such that the creator of the GUI application and the GUI application user perform the focus moving operation easily.

(Embodiment 5)

Embodiment 5 will explain the focus moving apparatus that moves focus according to the focus moving operation.

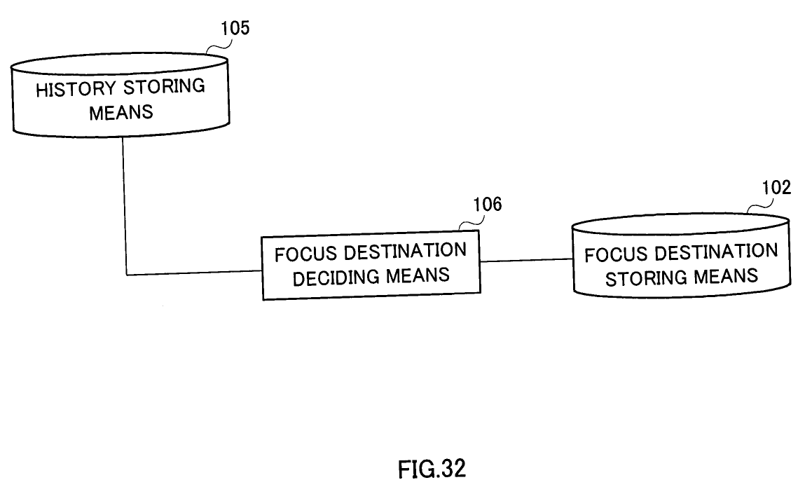

As shown in FIG. 32, this apparatus includes focus destination deciding means 106 that decides each GUI part at its focus destination and executes focus movement when the user performs a focus moving operation, history storing means 105 for storing focus movement histories, and focus destination storing means 102 of Embodiments 1 to 5. In addition, the focus destination deciding means 106 is implemented by the CPU 111 of the cellular phone 110 shown in FIG. 6 and programs stored in the memory 112. Moreover, the history storing means 105 is implemented by the CPU 111 and the memory 112.

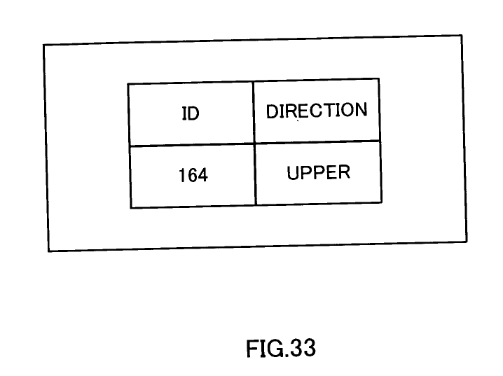

The history storing means 105 stores, as focus movement histories, a direction where a focus moving operation has been finally received (operational direction of the directional key 121) and an ID of the GUI part of a focus source. FIG. 33 shows one example of the focus movement histories stored by the history storing means 105. This example shows that the focus moving operation to the upper direction from the GUI part 164 has been performed.

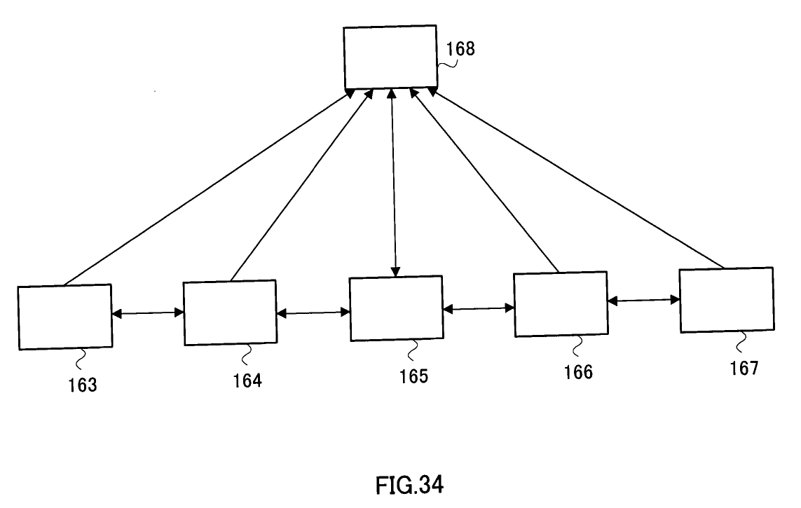

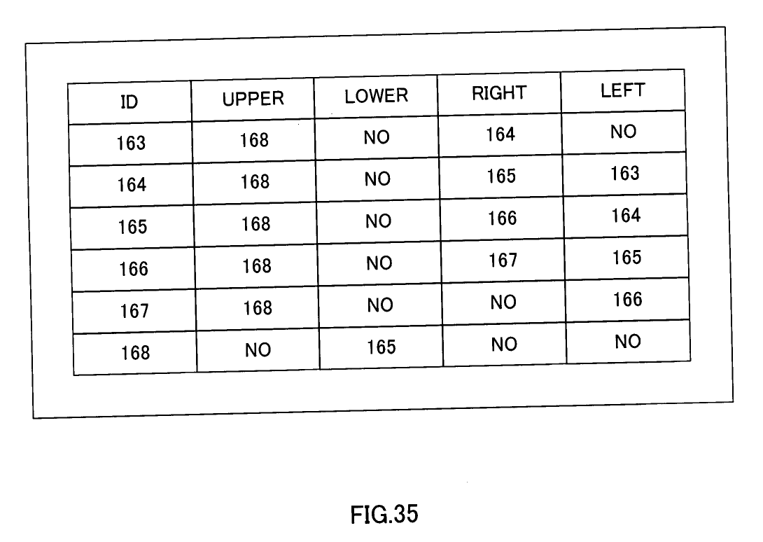

Moreover, for example, in connection with GUI parts 163 to 168 shown in FIG. 34, a focus destination list shown in FIG. 35 is stored in the focus destination storing means 102. The focus moving directions designated by this list are shown by arrows in FIG. 34.

The focus destination deciding means 106 decides a GUI part at its focus destination according to the focus destination list stored in the focus destination storing means 102 when the user performs a focus moving operation. In this case, when the focus moving operation performed by the user indicates focus movement to an opposite direction of an immediately preceding focus moving operation, the focus is moved to the GUI part, which has obtained the focus immediately before the operation, regardless of the designation of the focus destination list.

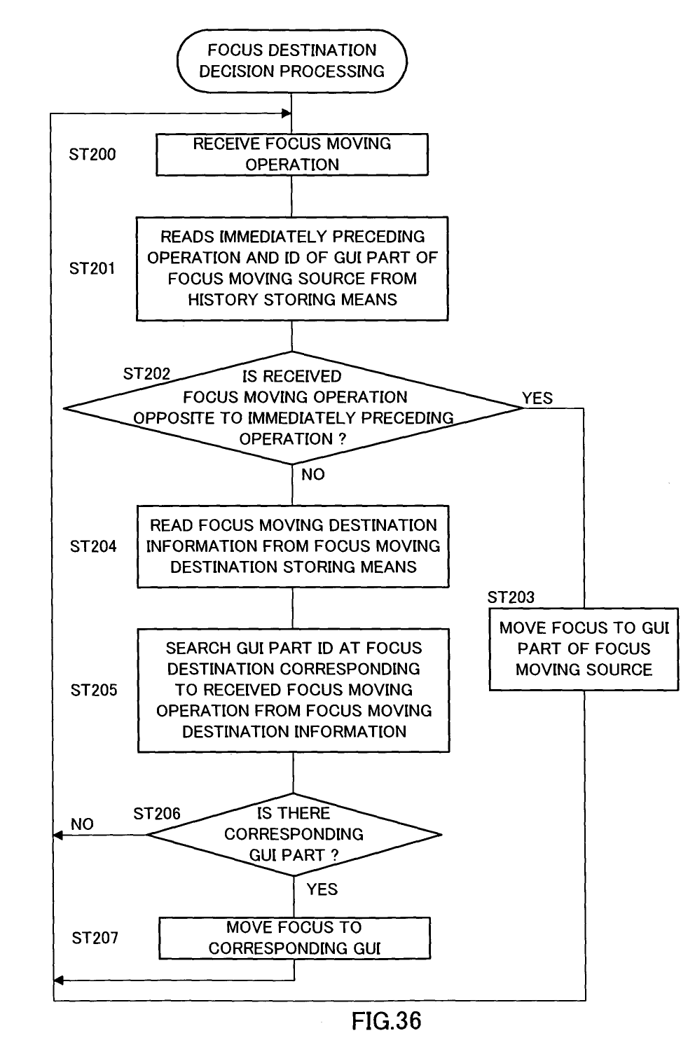

FIG. 36 shows a processing flow in which the focus destination deciding means 106 thus decides the focus destination.

Step ST201: After receiving the focus moving operation in step ST200, the focus destination deciding means 106 reads the direction where the focus moving operation is finally received from the history storing means 105 (operational direction of the directional key 121)and the ID of the GUI part of the focus moving source.

Step ST202: When the direction of the focus moving operation read from the history storing means 105 and the direction of the received focus moving operation are just opposite to each other, the focus destination deciding means 106 performs processing in step ST203. In other cases, the focus destination deciding means 106 performs processing in steps ST204 to ST207.

Step ST203: The focus destination deciding means 106 moves the focus to the read GUI part of the focus moving source. Thereafter, the focus destination deciding means 106 waits for the entry of a next focus moving operation.

Step ST204: The focus destination deciding means 106 reads information of a focus destination from the focus destination storing means 102.

Step ST205: The focus destination deciding means 106 searches an ID of the GUI part at the focus destination corresponding to the received focus moving operational direction from the read information of a focus destination.

Step ST206: In a case where there is the GUI part at the focus destination, the focus destination deciding means 106 performs processing in step ST207. In a case where there is no GUI part, the focus destination deciding means 106 waits for the entry of a next focus moving operation.

Step ST207: The focus destination deciding means 106 moves the focus to the searched GUI part at the focus destination. Thereafter, the focus destination deciding means 106 waits for the entry of a next focus moving operation.

In this way, when this focus moving apparatus receives the immediately preceding focus moving operation and the operation in the opposite direction, the focus is returned to the immediately preceding GUI part regardless of the setting of the focus destination list. Accordingly, when the user performs the focus moving operation to the upper direction from the GUI part 163 in FIG. 34 (upper directional operation of the directional key 121) and sequentially performs the focus moving operation to the lower direction (lower directional operation of the directional key 121), the focus, which has moved to the GUI part 168 according to the setting of the focus destination list at the time of the operation to the upper direction, can directly return to the GUI part 163 regardless of the setting of the focus destination list at the time of the operation to the lower direction.

For this reason, in a case where the user erroneously moves the focus to an unwanted direction, user can return the focus to the original state immediately by performing an operation to an opposite direction next.

Additionally, in this case, when the direction of the received focus moving operation is not the opposite direction of the immediately preceding focus moving operation, information of the focus destination is read from the focus destination storing means 102. Instead of this, it is possible to calculate the focus destination using the conventional focus destination calculation technique at this point.

Additionally, the aforementioned Embodiments 1 to 5 explained the case in which the GUI part focus destination setting apparatus 100 according to the present invention was provided to the cellular phone 100. The present invention is not limited to this. The present invention can be provided to various kinds of information equipment such as a personal computer (thereinafter referred to as PC), TV, PDA (Personal Digital Assistance), and the like.

As is obvious from the above explanation, the focus destination setting apparatus of the present invention can set the focus moving direction, which is suitable for the arrangement of GUI parts, and the focus moving direction where the user can perform operations easily, so that operability of the focus moving operation can be improved.

Moreover, the focus moving apparatus of the present invention can return the focus to the immediately preceding GUI part regardless of the setting of focus destination information. For this reason, in the case where the focus is moved to an unwanted direction, it is possible to return the focus to the original state immediately, so that operability of the focus moving operation can be improved.

Further, the focus destination setting apparatus of the present invention can set the focus moving direction, which is appropriate for the arrangement of the GUI parts, and the focus moving direction where the user can perform operations easily by suitably fixing the range in each direction, so that operability of the focus moving operation can be improved.

Furthermore, the focus moving apparatus of the present invention can return the focus to the immediately preceding GUI part regardless of the setting of focus destination information. For this reason, in the case where the focus is moved to an unwanted direction, it is possible to return the focus to the original state immediately, so that operability of the focus moving operation can be improved.

This application is based on the Japanese Patent Application No. 2001-278370 filed on Sep. 13, 2001, entire content of which is expressly incorporated by reference herein.

### Industrial Applicability

The present invention is suitable for use in the apparatus that presets, on a GUI screen, the focus destination of GUI part that moves based on the operational direction of operating means.

1. A GUI part focus destination setting apparatus comprising:
searching means for searching a destination GUI part of a focus, which moves based on an operational direction of operating means in a state that a target GUI part is used as a starting point, in a search range in each direction around the target GUI part; and
setting means for setting the searched GUI part as a destination of the focus corresponding to the operational direction where the target GUI part is used as a starting point,
wherein said searching means varies the search range.

2. A GUI part focus destination setting apparatus, which sets a GUI part of a focus destination in each direction when a focus is moved to each of a plurality of directions from each of a plurality of GUI parts, comprising:
GUI position information storing means for storing coordinates representing positions of each of the GUI parts;
range information storing means for storing range information that fixes a range in each direction for each GUI part;
focus destination calculating means for searching another GUI part, which is included in the range in each direction of a target GUI part and has the shortest distance from the target GUI part, based on the range information stored in said range information storing means and the coordinates of each GUI part stored in said GUI position information storing means;
focus destination storing means for storing the GUI part, as focus destination information, searched by said focus destination calculating means to be associated with the direction of the target GUI part.

3. The GUI part focus destination setting apparatus according to claim 2, wherein the directions are four directions of upper, lower, right, and left.

4. The GUI part focus destination setting apparatus according to claim 2, wherein the range information is information with contents using the GUI part, and said range information storing means stores the range information in accordance with the use of the contents.

5. The GUI part focus destination setting apparatus according to claim 2, wherein the entry of the range information is received at the time of obtaining a GUI application, and focus destination information in each direction of each GUI part is stored in said focus destination storing means before execution of the GUI application is started.

6. The GUI part focus destination setting apparatus according to claim 2, wherein when said focus destination calculating means finds out a GUI part, which is not set as a focus destination from any GUI part, with reference to the focus destination information stored in said focus destination storing means, said focus destination calculating means encourages reentry of the range information and searches another GUI part, which is included in the range in each direction of a target GUI part where focus destination information is undecided and has the shortest distance from the target GUI part, based on the reentered range information and the coordinates of each GUI part stored in said GUI position information storing means.

7. The GUI part focus destination setting apparatus according to claim 2, wherein when said focus destination calculating means finds out a GUI part, which is not set as a focus destination from any GUI part, with reference to the focus destination information stored in said focus destination storing means, said focus destination calculating means searches another GUI part, which is included in the range in each direction of a target GUI part where focus destination information is undecided and has the shortest distance from the target GUI part, based on the range information, which fixes the range in each of upper, lower, right and left directions equally, and the coordinates of each GUI part stored in said GUI position information storing means.

8. The GUI part focus destination setting apparatus according to claim 2, wherein a part of the focus destination information can be prestored in said focus destination storing means, and said focus destination calculating means does not perform search processing to change the prestored focus destination information.

9. The GUI part focus destination setting apparatus according to claim 2, wherein said focus destination storing means can change the stored focus destination information.

10. A focus moving apparatus, which moves a focus between GUI parts that form a GUI screen, upon reception of a user's focus moving operation, comprising:
history storing means for storing a moving operational direction at a previous focus moving time and a GUI part of a focus moving source; and
focus destination deciding means for comparing the user's focus moving operational direction with the moving operational direction stored in said history storing mean upon reception of the user's focus moving operation to return the focus to the GUI part of the focus moving source stored in said history storing means exceptionally only when both moving operational directions are opposite to each other.
